(19) United States
(12) Patent Application Publication
(10) Pub. No.: US 2002/0159046 A1
(43) Pub. Date: Oct. 31, 2002

(54) Base assembly for a stage chamber of a wafer manufacturing system

(75) Inventors: Michael Binnard, Belmont, CA (US); Andrew Hazelton, San Carlos, CA (US); Michael Kovalerchik, Castro Valley, CA (US)

Correspondence Address: FINNEGAN, HENDERSON, FARABOW, GARRETT &, DUNNER LLP, 1300 I STREET, NW, WASHINGTON, DC, 20005, US

(73) Assignee: Nikon Corporation

(21) Appl. No.: 09/843,076

(22) Filed: Apr. 27, 2001

(51) Int. Cl. G03B 27/42

(52) U.S. Cl. 355/74; 355/72; 355/75; 355/76; 355/53

(57) ABSTRACT

A base assembly is provided to support a wafer stage chamber assembly of a wafer manufacturing system. The wafer stage chamber assembly isolates semiconductor substrates from the atmosphere so that the resulted wafers have an improved quality and meet certain wafer manufacturing specifications. The base assembly includes a stage base to support the stage device, a base frame to support the stage base, and a plurality of support members to attach the base frame to an apparatus frame of the semiconductor substrate manufacturing apparatus. The base assembly also includes at least one mover base positioned adjacent the stage base to support at least one mover assembly. In addition, the base assembly is provided with an accessory channel to store accessories, such as cables, hoses, and wires, away from various moving parts in the wafer stage chamber assembly. The base assembly further includes a front shear panel having at least one loader port to provide access for the semiconductor substrates to go into and out of the wafer stage chamber assembly. On the underside of the stage base, there is a strengthening rib structure having a multi-radial configuration, each radial configuration centering on a pivotal support point for the stage device.

### BACKGROUND OF THE INVENTION

1. Field of the Invention

This invention relates to a base assembly for a stage chamber of a wafer manufacturing system. More particularly, this invention relates to such a base assembly for supporting a stage device, such as a wafer stage device, and a wafer stage chamber assembly in a photolithography process to manufacture semiconductor substrates.

2. Description of the Related Art

In manufacturing integrated circuits using a photolithography process, light is transmitted through non-opaque portions of a pattern on a reticle, or photomask, through a projection exposure apparatus, and onto a wafer of specially-coated silicon or other semiconductor material. The uncovered portions of the coating that are exposed to light, are cured. The uncured portions of the coating are removed by an acid bath. Then, the layer of uncovered silicon is altered to produce one layer of the multi-layered integrated circuit. Conventional systems use visible and ultraviolet light for this process. Recently, however, visible and ultraviolet light have been replaced with electron, x-ray, and laser beams, which permit smaller and more intricate patterns.

As the miniaturization of a circuit pattern progresses, the focus depth of the projection exposure apparatus becomes very small, making it difficult to align accurately the overlay of circuit patterns of the multi-layered integrated circuit. As a result, a primary consideration for an overall design of the photolithography system includes building components of the system that achieve precision by maintaining small tolerances. Any vibration, distortion, or misalignment caused by internal, external or environmental disturbances must be kept at minimum. When these disturbances affect an individual part, the focusing properties of the photolithography system are collectively altered.

In a conventional exposure apparatus of a photolithography system to manufacture semiconductor wafers, a wafer stage assembly is used in combination with a projection lens assembly. The wafer stage assembly includes a wafer table to support the wafer substrates, a wafer stage to position the wafer substrates as the wafer stage is being accelerated by a force generated in response to a wafer manufacturing control system, and a wafer stage base to support the wafer stage. The wafer manufacturing control system is the central computerized control system.

The exposure apparatus generally includes an apparatus frame that rigidly supports the wafer stage assembly, the projection lens assembly, the reticle stage assembly, and an illumination system. In operation, the exposure apparatus transfers a pattern of an integrated circuit from a reticle onto the wafer substrates. To permit smaller and more intricate circuit pattern, the projection lens assembly must accurately focus the energy beam on a targeted exposure point of the wafer substrate to align the overlay of circuit patterns of the multi-layered integrated circuit. The exposure apparatus can be mounted to a base, such as the ground or via a vibration isolation system.

There are several different types of photolithography devices, including, for example, a scanning type and a step-and-repeat type. In the scanning type photolithography system, the illumination system exposes the pattern from the reticle onto the wafer with the reticle and the wafer moving synchronously. The reticle stage moves the reticle in a plane which is generally perpendicular to the optical axis of the lens assembly, while the wafer stage moves the wafer in another plane generally perpendicular to the optical axis of the lens assembly. Scanning of the reticle and wafer occurs while the reticle and wafer are moving synchronously.

Alternatively, in the step-and-repeat type photolithography system, the illumination system exposes the reticle while the reticle and the wafer are stationary. The wafer is in a constant position relative to the reticle and the lens assembly during the exposure of an individual field. Subsequently, between consecutive exposure steps, the wafer is consecutively moved by the wafer stage perpendicular to the optical axis of the lens assembly so that the next field of the wafer is brought into position relative to the lens assembly and the reticle for exposure. Following this process, the images on the reticle are sequentially exposed onto the fields of the wafer.

In most types of photolithography systems, the photolithography process of the conventional exposure apparatus is performed with the semiconductor substrates exposed to the atmosphere.

Recent developments enabling the photolithography process to meet certain wafer manufacturing specifications and to improve the quality of the resulted wafers require that the semiconductor substrates be processed in a controlled atmosphere, such as nitrogen or helium. To take advantage of the recent developments, a wafer stage chamber assembly has been proposed to isolate the semiconductor substrates, the wafer stage device, and the manufacturing process thereof from the atmosphere.

### SUMMARY OF THE INVENTION

The advantages and purposes of the invention will be set forth in part in the description which follows, and in part will be obvious from the description, or may be learned by practice of the invention. The advantages and purposes of the invention will be realized and attained by the elements and combinations particularly pointed out in the appended claims.

To attain the advantages and consistent with the principles of the invention, as embodied and broadly described herein, one aspect of the invention is a base assembly for a stage chamber assembly of a stage device. The stage device is used in an exposure apparatus to manufacture semiconductor substrates. The base assembly comprises a base frame to kinematically support the stage device, the base frame having a front section and a rear section, and a plurality of support members to kinematically support the stage chamber assembly, the plurality of support members removably attaching the base frame to a frame of the semiconductor substrate manufacturing apparatus.

Another aspect of the present invention is abase assembly for a stage device. The stage device has a stage device and at least one mover assembly. The base assembly comprises a stage base to support the stage device, and at least one mover base to support the at least one mover assembly.

A further aspect of the present invention is a stage device for use in an exposure apparatus to manufacture semiconductor substrates. The stage device comprises a stage base to support the stage device. An underside of the stage base has a strengthening rib structure wherein the strengthening rib structure has a multi-radial configuration, each radial configuration centering on a pivotal support point for the stage device.

It is to be understood that both the foregoing general description and the following detailed description are exemplary and explanatory only and are not restrictive of the invention as claimed. Additional advantages will be set forth in the description which follows, and in part will be understood from the description, or may be learned by practice of the invention. The advantages and purposes may be obtained by means of the combinations set forth in the attached claims.

### BRIEF DESCRIPTION OF THE DRAWINGS

The accompanying drawings, which are incorporated in and constitute a part of this specification, illustrate several embodiments of the invention and, together with the description, serve to explain the principles of the invention. In the drawings,

FIG. 1 is an exploded perspective frontal view of a wafer stage chamber assembly;

FIG. 2 is a perspective frontal view of a base assembly of the present invention for supporting the wafer stage chamber assembly shown in FIG. 1;

FIG. 3 is a perspective rear view of the base assembly shown in FIG. 2;

FIG. 4 is an exploded perspective frontal view of the base assembly shown in FIGS. 2 and 3;

FIG. 5 is a perspective view of the base assembly including a wafer stage assembly;

FIG. 5A is a schematic perspective view of an alternative embodiment of a wafer stage base consistent with the principles of the present invention;

FIG. 5B is a schematic perspective view of another alternative embodiment of the wafer stage base consistent with the principles of the present invention;

FIG. 5C is a side view of the base assembly in partial cross-section illustrating an accessory channel according to one embodiment of the present invention;

FIG. 6A is a semi-exploded perspective rear view of the base assembly illustrating reference area A when removed from an exposure apparatus;

FIG. 6B is a semi-exploded perspective rear view of the base assembly illustrating a wedge jack consistent with the principles of the present invention;

FIG. 6C is an enlarged side view of the wedge jack of FIG. 6B;

FIG. 7 is a bottom plan view of an underside of a stage base consistent with the principles of the present invention;

FIG. 8 is a perspective view of the underside of the stage base of FIG. 7;

FIG. 9 is a perspective rear view of a base frame consistent with the principles of the present invention;

FIG. 10 is an exploded perspective rear view of the base frame of FIG. 9;

FIG. 11 is an elevation view of an exposure apparatus with the wafer stage chamber assembly and base assembly consistent with the principles of the present invention;

FIG. 12 is an elevation view of the exposure apparatus without the wafer stage chamber assembly;

FIG. 13 is a flow chart outlining a process for manufacturing a semiconductor wafer consistent with the principles of the present invention; and

FIG. 14 is a flow chart outlining the semiconductor manufacturing process in further detail.

### DESCRIPTION OF THE INVENTION

Reference will now be made in detail to several embodiments of the present invention, examples of which are illustrated in the accompanying drawings. The invention will be further clarified by the following examples, which are intended to be exemplary of the invention.

The apparatus and assembly of the present invention are directed to a base assembly of a wafer stage chamber assembly for enclosing a wafer stage assembly in a semiconductor wafer manufacturing apparatus. The principles of this invention are similarly applicable to other parts of the photolithography system, such as a reticle stage assembly. Thus, this invention is not limited to any particular application, but rather is broadly applicable to other parts as well.

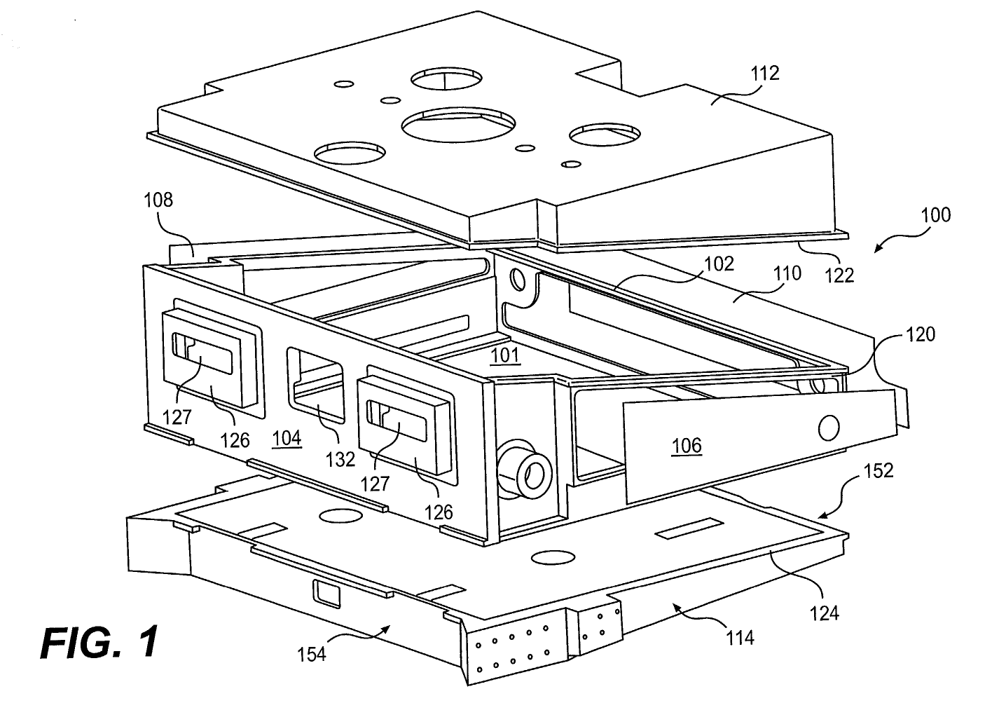

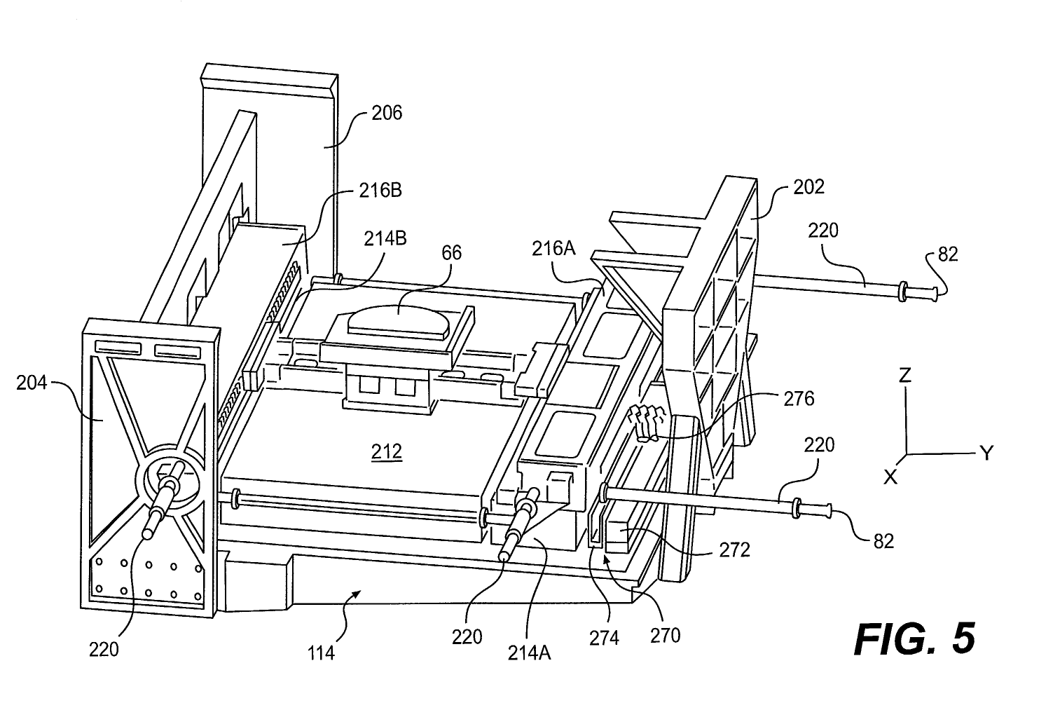

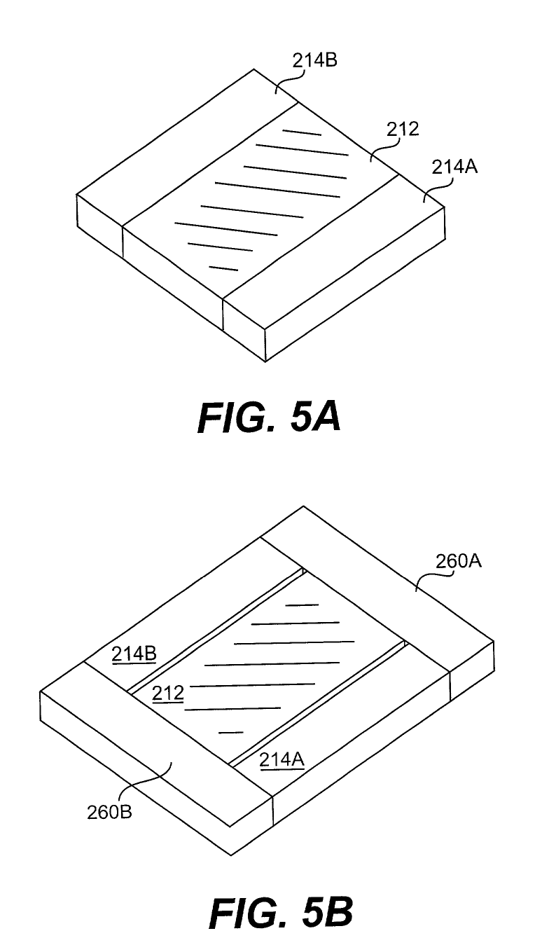

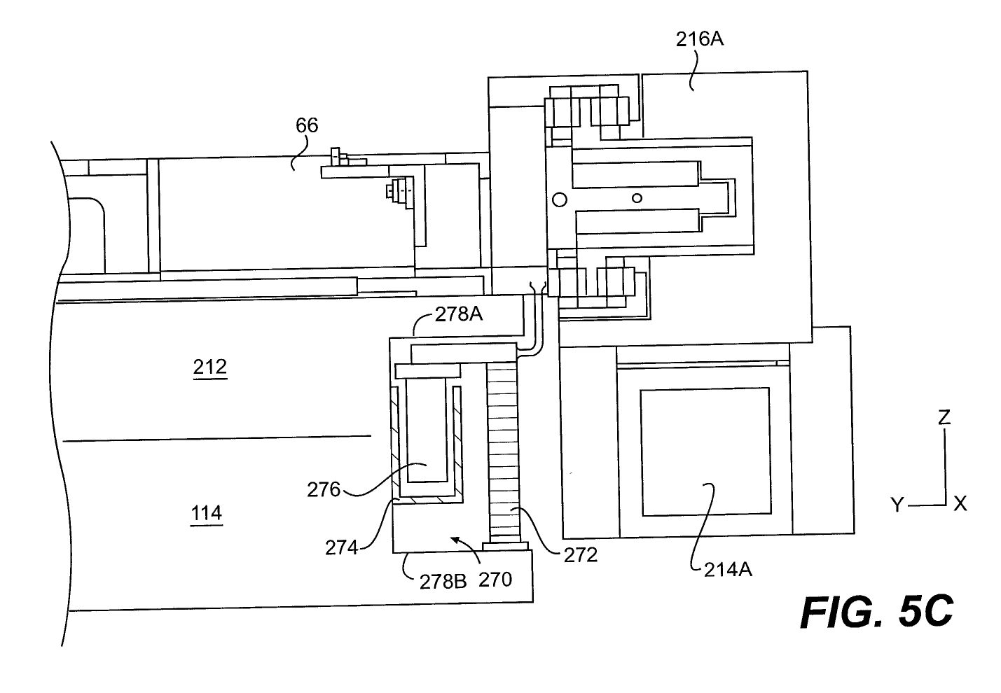

For purposes of understanding the present invention, the wafer stage chamber assembly will be discussed briefly. The wafer stage chamber assembly is described in detail in co-pending U.S. application Ser. No. ______ (attorney reference no. 7303.0034, PAO358-US), the entire disclosure of which is incorporated by reference. As illustrated in FIG. 1, a wafer stage chamber assembly 100 for use in manufacturing semiconductor substrates comprises a wafer stage chamber 101 constructed of a chamber frame 102 to enclose a wafer stage device 66 (shown in FIG. 5), and a plurality of chamber walls or panels 104, 106, 108, and 110 attached to chamber frame 102. Chamber frame 102 defines the shape of wafer stage chamber assembly 100, and may be made of steel plates and permanently fastened, such as by welding, to construct chamber frame 102. To isolate the interior of wafer stage chamber assembly 100 from the external atmospheric condition, vibration, and other disturbances, chamber frame 102 is provided with a plurality of grooves 120 around the border where each of the chamber panels 104, 106, 108, and 110 is to be attached for receiving a sealing material. Similarly, top wall 112 has a first sealing flange 122 around the border to seal the engagement between top wall 112 and chamber frame 102. Likewise, base frame 114 has a second sealing surface 124 around the border to seal the engagement between base frame 114 and chamber frame 102. The sealing material may be a commercially available o-ring seal.

The base assembly according to the present invention comprises the base frame to support the wafer stage device and a plurality of support members to attach the base frame to a frame of the semiconductor substrate manufacturing apparatus.

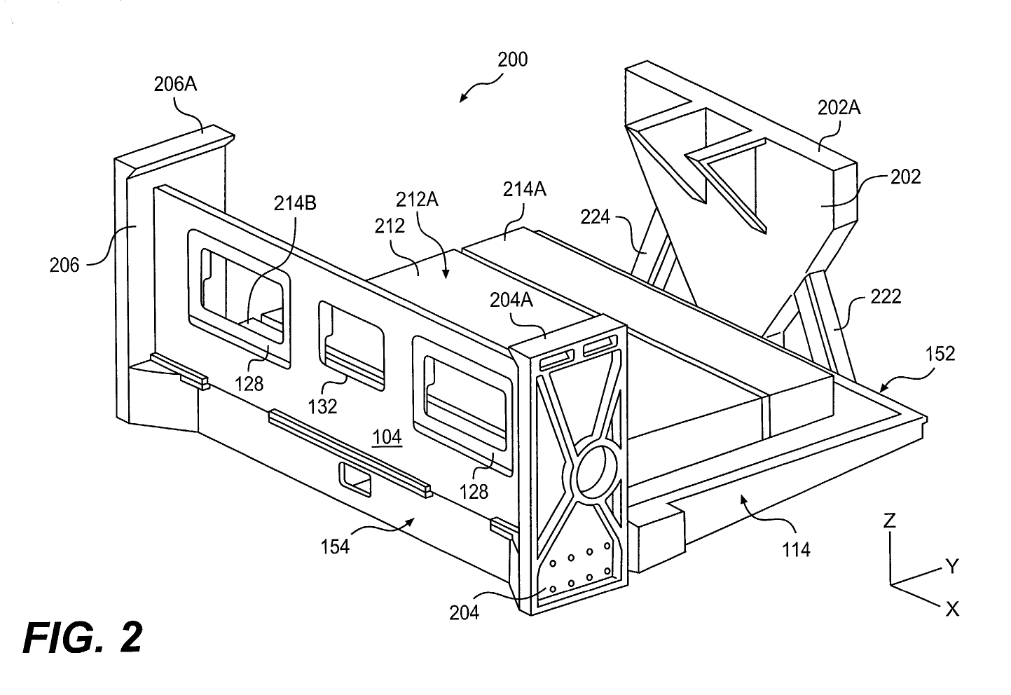

In the embodiment illustrated in FIGS. 2-4, a base assembly 200 includes the base frame 114, a stage base 212 and at least one reaction frame base 214A, 214B. To minimize any disturbances and to achieve the required precision in a sensitive system, such as the exposure apparatus to manufacture semiconductor substrates, wafer stage 66 is provided on an air bearing support (not shown) so that wafer stage 66 levitates above stage base 212. Stage base 212 preferably has a top flat surface 212A. In one embodiment, stage base 212 and at least one reaction frame base 214A, 214B are made of ceramic, and have a top flat surface 212A with a tolerance of within at most 10 micrometers. An underside of wafer stage 66 is provided with a plurality of pneumatic channels (not shown). To generate the air bearing support, some of the pneumatic channels are connected to a source of compressed air to expel jets of high-pressure air toward top flat surface 212A, and the rest of the pneumatic channels are connected to a vacuum source to draw in the high-pressure air. Using a plurality of valves (not shown) to monitor the air pressure and suctioning action, the air bearing support may be controlled so that stage device 66 steadily levitates above stage base 212 at a desired height, such as, within approximately 5 micrometers.

In the embodiment illustrated in FIGS. 2-4, stage base 212 is provided between a pair of mover bases (reaction frame bases) 214A and 214B. As shown in FIG. 5, stage base 212 supports a wafer stage 66, and mover bases 214A, 214B support a pair of mover assemblies 216A, 216B, respectively. Mover assemblies 216A, 216B include the reaction canceler device as a reaction frame and absorb reaction forces (not shown) generated by the movement of wafer stage 66, and thereby, stabilize the overall wafer stage chamber assembly 100. Mover assemblies 216A, 216B generate forces (not shown) to move wafer stage 66. Mover assemblies 216A, 216B may include a plurality of connection assemblies 220 to connect mover assemblies 216A and 216B, for example, to stationary surfaces, such as the ground, or to a vibration isolating system (not shown). Connection assemblies 220 are further described in U.S. patent application Ser. No. ______ (attorney reference no. 7303.0033, PAO376), the entire disclosure of which is incorporated by reference.

Alternatively, in the embodiment illustrated in FIG. 5A, stage base 212 and mover bases 214A, 214B are fastened to each other by using a plurality of mechanical fasteners (not shown), such as, nuts and bolts, clamps, etc. Further alternatively, in the embodiment illustrated in FIG. 5B, stage base 212 and mover bases 214A, 214B may be supported by a pair of stiff outer frames or base supports 260A, 260B. Base supports 260A, 260B may fasten stage base 212 and mover bases 214A, 214B thereto by conventional fasteners, such as screws, nuts and bolts, clamps, adhesive, or equivalents.

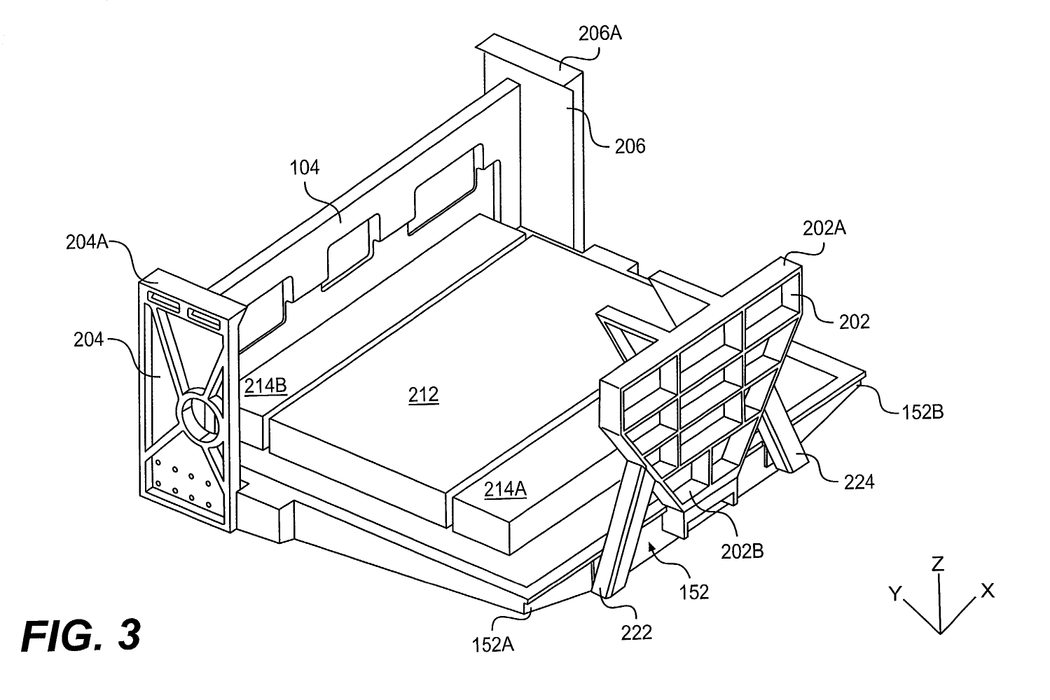

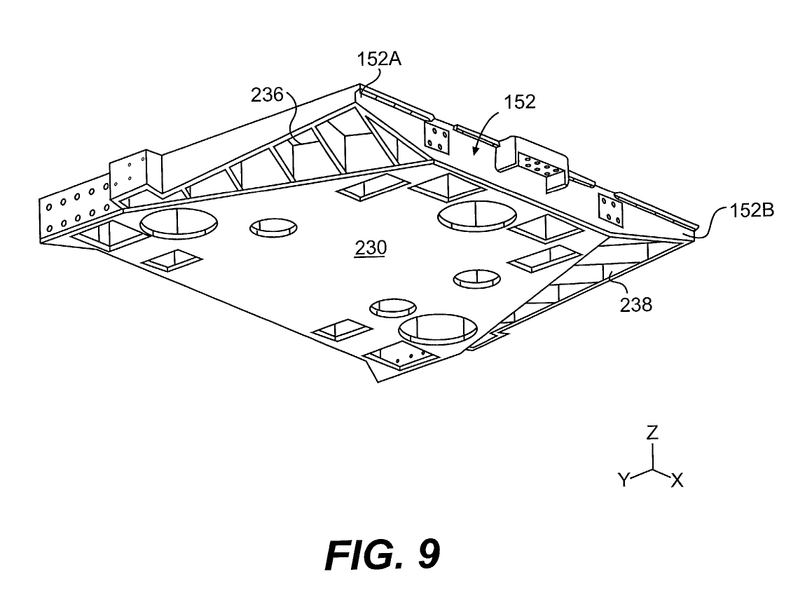

Base frame 114 supports stage base 212 and at least one mover base 214A, 214B. Base frame 114 has a front section 154 and a rear section 152. In the illustrated embodiment, best shown in FIGS. 3, 9, and 10, the rear corners 152A and 152B of base frame 114 are tapered along the x- and y-axes provided for higher vibration frequency and to reduce the weight of base frame 114. Tapering improves the vibration frequency by removing mass from rear corners 152A, 152B where stiffness is not required. Base frame 114 may be made of a large metal casting. To prevent outgassing, the casting may be sealed by filling all the voids in the casting with a sealing compound, for example, a polymer or epoxy.

According to the invention, wafer stage chamber assembly 100 and base frame 114 are kinematically supported by a plurality of body supports 202, 204, and 206. The term kinematic means that a component or an assembly is supported with exactly the necessary amount of constraint without over constraining. Thus, three (3) body supports 202, 204, 206 kinematically support wafer stage chamber assembly 100 without over constraining base frame 114.

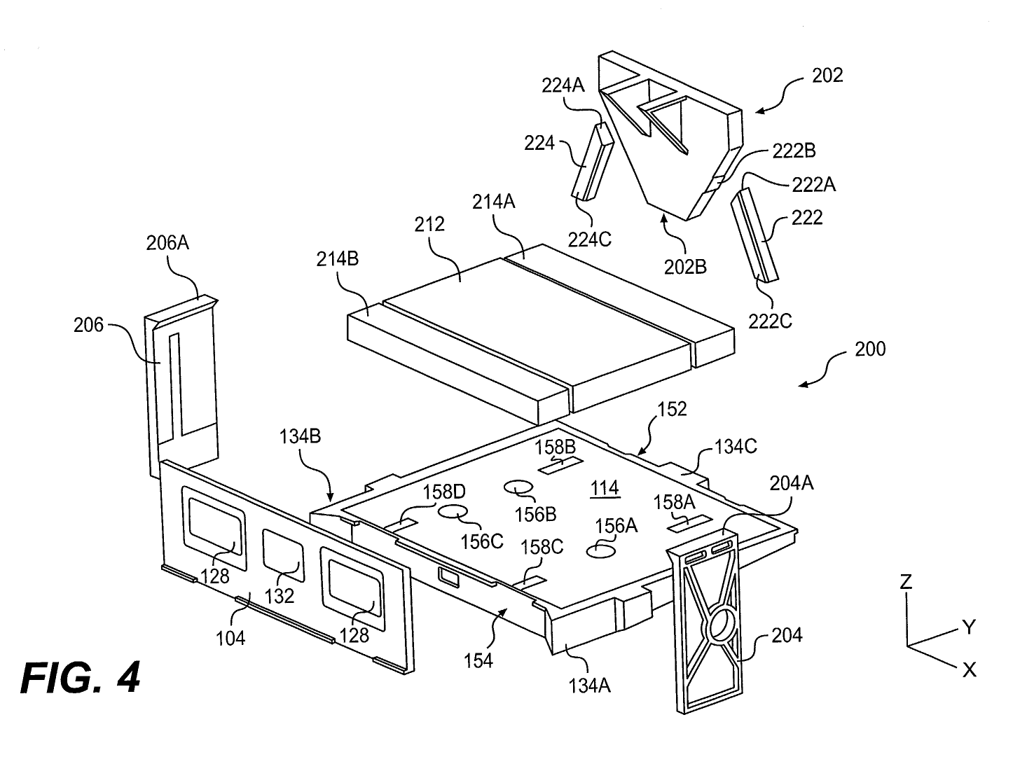

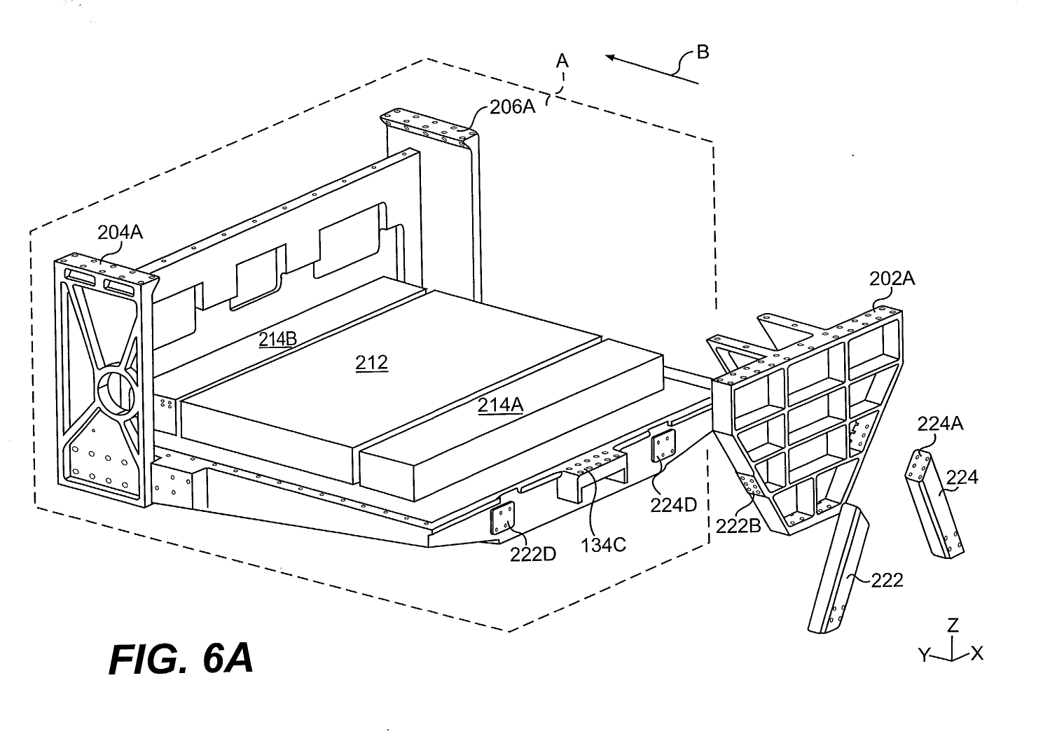

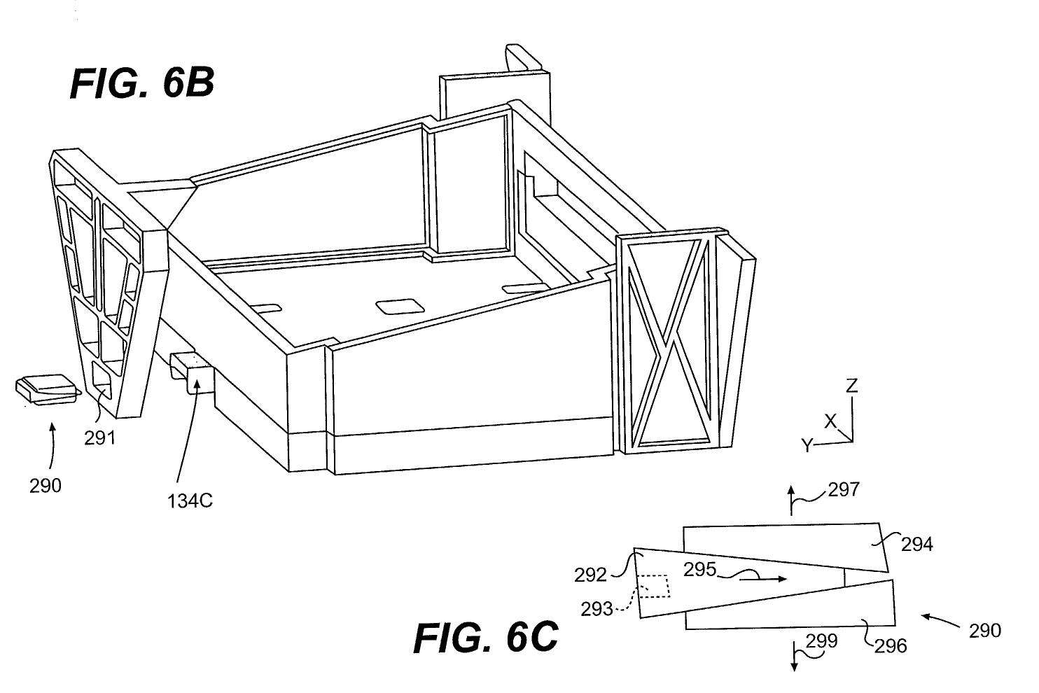

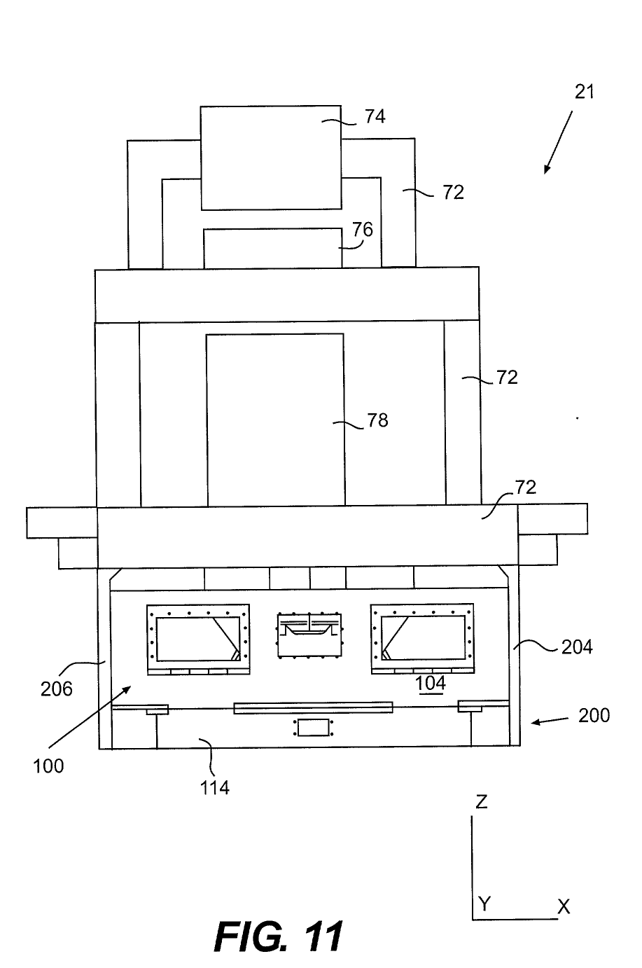

Body support 202 is provided on rear section 152, while body supports 204 and 206 are on front section 154. Rear body support 202 may additionally be provided with a pair of support struts 222, 224. Each of body supports 202, 204, and 206 has a top mounting surface 202A, 204A, and 206A, respectively, for connecting wafer stage chamber assembly 100 to an exposure apparatus 21, such as the apparatus frame 72 of exposure apparatus 21 (shown in FIG. 11) of the semiconductor substrate manufacturing apparatus. Rear body support 202 may also have a bottom mounting surface 202B (shown in FIG. 3) for connecting rear body support 202 to a rear support mounting surface 134C (shown in FIG. 4) of base frame 114. Similarly, support struts 222, 224 may have a plurality of mounting surfaces, including mounting surfaces 222A, 224A to correspond with respective mounting surfaces (only 222B is shown in FIG. 4) on rear body support 202, and mounting surfaces 222C, 224C to correspond with mounting surfaces 222D, 224D, respectively (shown in FIG. 6A) on the rear section 152 of base frame 114. Mechanical fasteners (not shown), for example, bolts, screws, clamps, or equivalents, may be used to fasten body supports 202, 204, 206, and support struts 222, 224, to base frame 114 and to apparatus frame 72.

Base assembly 200 further includes the front panel 104, which is a shear panel, attached to front section 154 of base frame 114. Shear panel 104 has sufficient stiffness to prevent front section 154 of base frame 114 from vibrating in the X direction. For example, in one embodiment, front shear panel 104 is made of stainless steel having a thickness of approximately 20 mm. Shear panel 104 has at least one loader port 126 (two are shown in FIGS. 1-6A and 11). Each loader port 126 is provided with a loader window 127 to provide access for the semiconductor substrates to go into and out of wafer stage chamber assembly 100. For each loader port 126, a corresponding loader opening 128 is provided on shear panel 104. Shear panel 104 may also have a climate access window 132 positioned between a pair of loader ports 126 to provide access into wafer stage chamber assembly 100, for example, to connect an air conditioning duct (not shown). Alternatively, window 132 may be used to allow an operator to monitor operations of wafer stage 66 and other parts inside wafer stage chamber assembly 100. Loader openings 128 and window 132 are preferably sealed to maintain the pressure and/or controlled atmospheric condition inside wafer stage chamber assembly 100.

As shown in FIG. 5, base assembly 200 may include an accessory channel 270 for storing cables, hoses, and wires (collectively referred to as 272) away from the various moving parts in wafer stage chamber assembly 100. In this embodiment, the wafer stage chamber assembly 100 is installed to a scanning type exposure apparatus, and the y direction in the drawing is set as a scanning direction of the exposure apparatus. Accessory channel 270 also provides space for a motor, such as a linear motor, shown as a U-shaped magnet 274 and a moving coil 276. In the illustrated embodiment, accessory channel 270 runs parallel along the x-axis, and is positioned on base frame 114 sandwiched between mover base 214A and rear body support 202. Alternatively, in the embodiment illustrated in FIG. 5C, accessory channel 270 also runs parallel along the x-axis, but is provided in a cut-out portion between stage base 212 and base frame 114. The cut-out portion on stage base 212 is represented by reference number 278A, and the cut-out portion on base frame 114 by reference number 278B.

As illustrated in FIG. 4, base frame 114 may include a plurality of support mounting surfaces 134A, 134B, 134C, for attaching base assembly 200 via body supports 202, 204, 206 to apparatus frame 72, such that base assembly 200 is supported by body supports 202, 204, 206 and hangs from apparatus frame 72. A pair of support mounting surfaces 134A, 134B are positioned on front section 154 of base frame 114 and the rear support mounting surface 134C is positioned on rear section 152.

Occasionally, wafer stage chamber assembly 100 needs to be removed from exposure apparatus 21, for example, for servicing purposes, periodic maintenance, or other reasons. As shown in FIG. 6A, to remove wafer stage chamber assembly 100, the procedure begins by loosening the fasteners at support mounting surfaces 204A, 206A, 134C. Similarly, if rear body support 202 includes support struts 222, 224, the fasteners securing support struts 222 and 224 at strut mounting surfaces 222D and 224D, respectively, are loosened. The fasteners at mounting surface 202A connecting rear body support 202 to apparatus frame 72 remain secured. Thereafter, to remove wafer stage chamber assembly 100, the wafer stage chamber assembly 100, only base assembly 200 as illustrated and represented by reference area A, may slide out toward the front side of exposure apparatus 21 as indicated by arrow B.

To facilitate accessing the rear section 152 of base assembly 200, particularly when an operator has limited space to work with when loosening fasteners on mounting surfaces 134C, 222D, 224D, a wedge jack 290, illustrated in FIG. 6B, may be provided to replace conventional mechanical fasteners. Correspondingly, rear body support 202 is provided with a wedge opening 291 to accommodate wedge jack 290. Wedge jack 290 includes a driving wedge 292 sandwiched between wedge portions 294, 296. Driving wedge 292 has a threaded opening 293 to receive a threaded key, such as a screw (not shown).

In operation, to fasten base assembly 200 to rear body support 202, the operator may use a wrench (not shown) to drive the screw along the negative y-axis direction and push driving wedge 292 in the direction shown by arrow 295. Because of the geometry of wedge jack 290, driving wedge 292 then pushes wedge portions 294, 296 in the direction shown by arrows 297, 299, respectively, creating a locking engagement between rear body support 202 and base assembly 200. Conversely, to loosen base assembly 200, the operator may loosen the screw by retracting driving wedge 292 along the positive y-axis direction and loosening wedge portions 294, 296 releasing the locking engagement.

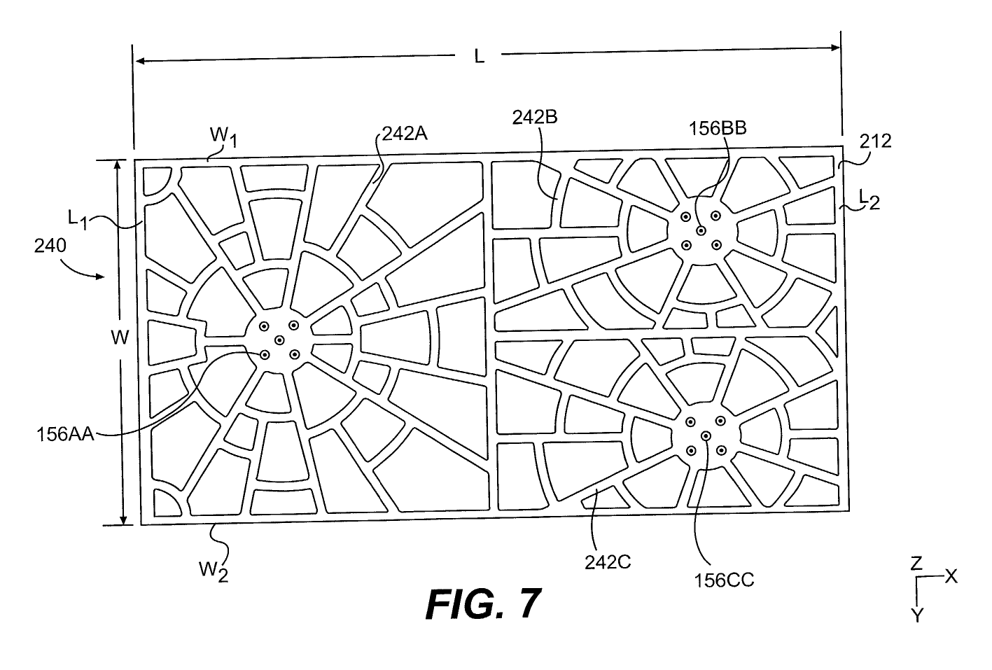

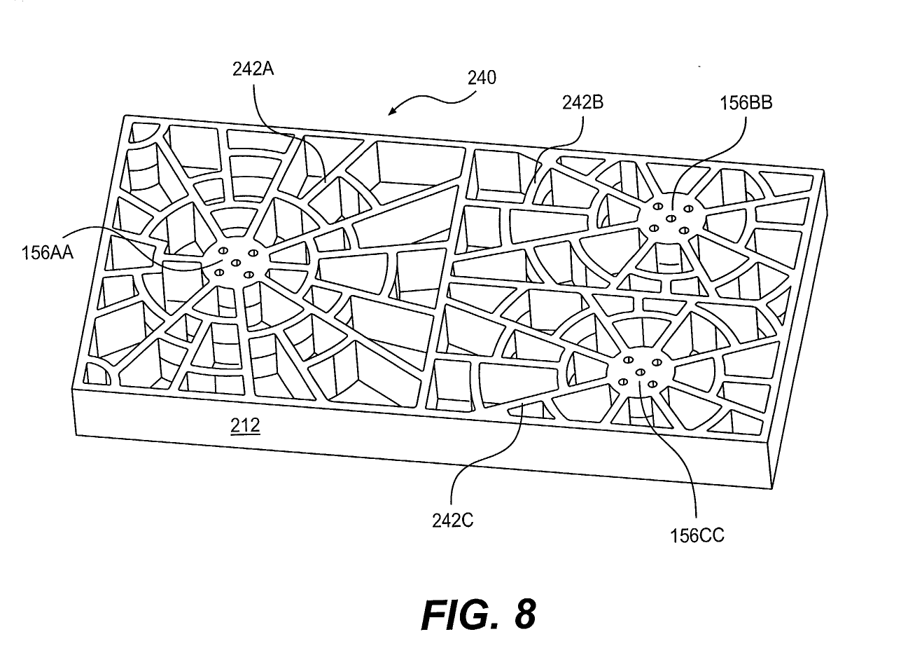

An underside of stage base 212 may have a rib structural design 240, as illustrated in FIGS. 7 and 8, to strengthen stage base 212. The stage base strengthening rib structure 240 has a multi-radial configuration whereby each radial configuration centers on a pivotal point. To provide a kinematic support to stage base 212 and to thereby minimize distortion, three pivotal points may be predetermined using a computer model for supporting and stabilizing wafer stage 66, as well as other parts in wafer stage chamber assembly 100, due to the motion therein. In the illustrated embodiment, the pivotal support points for stage base 212 occur at reference numbers 156AA, 156BB, and 156CC. Accordingly, each radial rib structure 242A, 242B, or 242C, and segments thereof concentrically propagate from the corresponding pivotal support point 156AA, 156BB, or 156CC, respectively.

For example, in the embodiment illustrated in FIG. 7, stage base 212 has a width W extending from top edge WI to bottom edge W2, and a length L extending from left edge L1 to right edge L2. According to the computer model, pivotal support point 156AA occurs at a position approximately ½W from either edge W1 or W2, and approximately between L/5 and L/3 from left edge L1. Pivotal support point 156BB occurs at a position approximately between W/5 and W/3 down from top edge W1, and approximately between L/5 and L/3 from right edge L2. Similarly, pivotal support point 156CC occurs at a position approximately between W/5 and W/3 up from bottom edge W2, and approximately between L/5 and L/3 from left edge L2. strengthening rib structure 240

Base frame 114 may include a plurality of attachment ports 156A, 156B, and 156C (shown in FIG. 4) for attaching component(s) to base frame 114. In the illustrated embodiment, attachment ports 156A, 156B, 156C are provided to attach stage base 212 to base frame 114. In the illustrated embodiment, attachment ports 156A, 156B, and 156C are positioned in accordance with the positions of pivotal support points 156AA, 156BB, and 156CC, respectively, to provide maximum support to stage base 212. In addition, base frame 114 may also include a plurality of attachment ports 158A, 158B, 158C, and 158D to attach reaction frame bases 214A, 214B, respectively, to base frame 114.

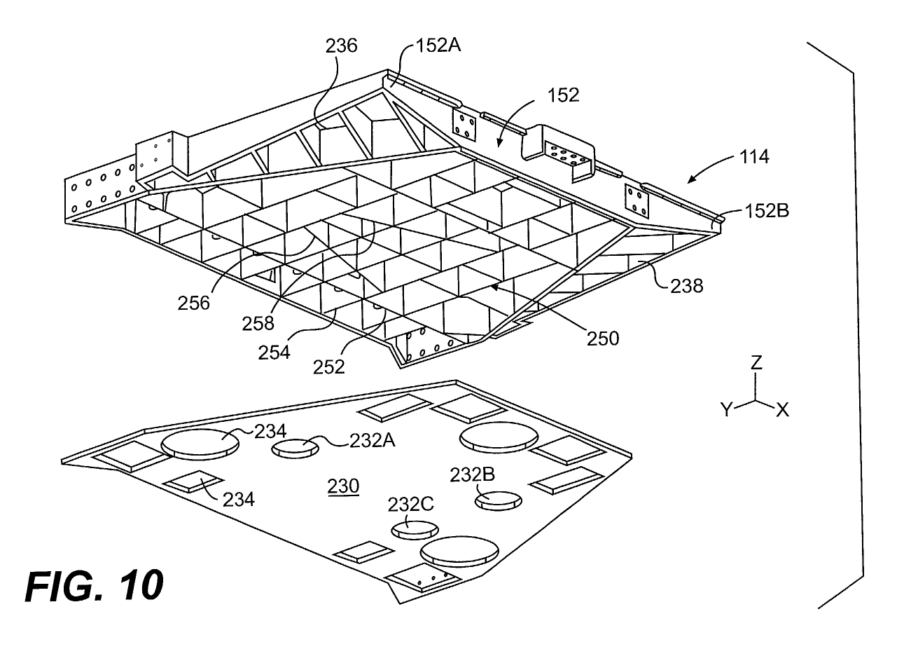

Base assembly 200 may further include a bottom plate 230 (best shown in FIG. 10) attachable to an underside of base frame 114 to add stiffness and strength to base frame 114. Bottom plate 230 has a plurality of openings, some having circular configuration, while others rectangular. For example, openings 232A, 232B, 232C are positioned corresponding to the positions of attachment ports 158A, 158B, 158C, respectively, to provide access for fastening or loosening stage base 212 to base frame 114. Similarly, other openings, such as those cumulatively referred to as 234, may be provided to access other components of wafer stage chamber assembly 100.

In the illustrated embodiment, because of tapered corners 152A and 152B, bottom plate 230 does not cover areas 236 and 238 on the underside of base frame 114. Alternatively, bottom plate 230 may include bottom sub-plates (not shown) to cover areas 236 and 238. Also in the alternative, if corners 152A and 152B are not tapered, bottom plate 230 may cover the whole underside area of base frame 114. A further alternative includes bottom plate 230 being made an integral part of base frame 114.

An underside of base frame 114 may have a rib structural design 250, as illustrated in FIG. 10, to strengthen base frame 114. Base frame strengthening rib structure 250 includes a plurality of rib segments 252 and 254, which may be parallel to the x- and y-axes, respectively. Base frame strengthening rib structure 250 may also include rib segments 256 and 258 which correspond to the positions of pivotal support points 156AA, 156BB, and 156CC, i.e., rib segment 256 connecting pivotal support points 156AA and 156CC, and rib segment 258 connecting pivotal support points 156AA and 156BB. Further, base frame strengthening rib structure 250 may include rib segments for areas 236 and 238 positioned at an angle with respect to the xy-plane. In addition, a plurality pieces of damping elements (not shown), such as strips of rubber or plastic cushion, may be provided on the base frame strengthening rib structure 250 to be sandwiched between base frame 114 and bottom plate 230.

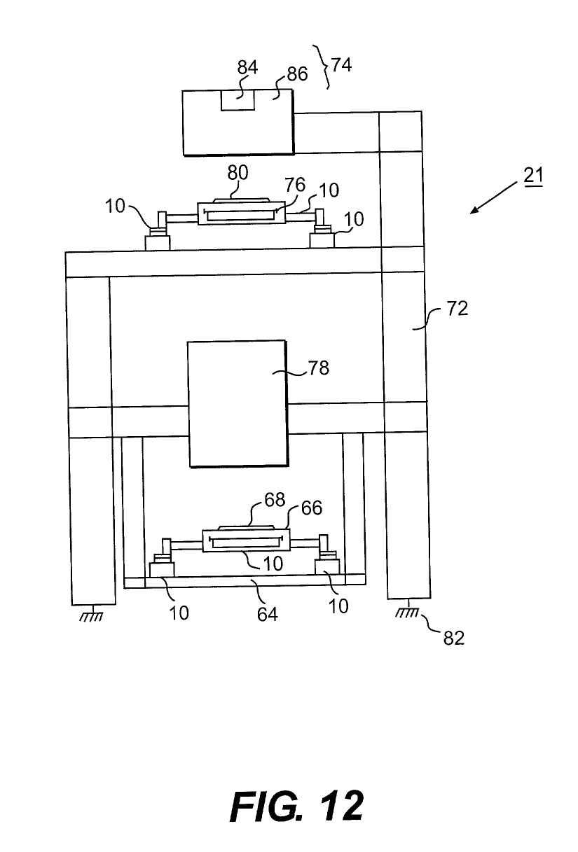

FIG. 11 illustrates wafer stage chamber assembly 100 supported by base assembly 200 consistent with the principles of the present invention and attached to exposure apparatus 21 of a photolithography system to manufacture semiconductor wafers 68. FIG. 12 illustrates another exposure apparatus 21 without wafer stage chamber assembly 100 nor base assembly 200. Wafer stage assembly 66 positions the semiconductor wafer 68 as wafer stage assembly 66 is being accelerated by a stage force (not shown) generated in response to the wafer manufacturing control system (not shown), which is the central computerized control system executing the wafer manufacturing process.

Apparatus frame 72 supports projection lens assembly 78. In operation, exposure apparatus 21 transfers a pattern of an integrated circuit from reticle 80 onto semiconductor wafer 68. Exposure apparatus 21 can be mounted to a base 82, i.e., the ground or via a vibration isolation system (not shown). Apparatus frame 72 is rigid and supports the components of exposure apparatus 21, including reticle stage assembly 76, wafer stage assembly 66, projection lens assembly 78, and illumination system 74.

Illumination system 74 includes an illumination source 84 to emit a beam of light energy. Illumination system 74 also includes an illumination optical assembly 86 to guide the beam of light energy from illumination source 84 to projection lens assembly 78. The beam selectively illuminates different portions of reticle 80 and exposes wafer 68.

Projection lens assembly 78 projects and/or focuses the light passing through reticle 80 to wafer 68. Projection lens assembly 78 may magnify or reduce the image illuminated on reticle 80. Projection lens assembly 78 may also be a 1× magnification system.

Reticle stage assembly 76 holds and positions reticle 80 relative to projection lens assembly 78 and wafer 68. Similarly, wafer stage assembly 66 holds and positions wafer 68 with respect to the projected image of the illuminated portions of reticle 80. Wafer stage assembly 66 and reticle stage assembly 76 are moved by a plurality of motors 10.

The use of exposure apparatus 21 provided herein is not limited to a photolithography system for a semiconductor manufacturing. Exposure apparatus 21, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

The illumination source 84 can be g-line (436 nm), i-line (365 nm), KrF excimer laser (248 nm), ArF excimer laser (193 nm) and F₂ laser (157 nm). Alternatively, illumination source 84 can also use charged particle beams such as x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to projection lens assembly 78, when far ultra-violet rays such as the excimer laser is used, glass materials such as quartz and fluorite that transmit far ultra-violet rays is preferably used. When the F₂ type laser or x-ray is used, projection lens assembly 78 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as wall as Japan Patent Application Disclosure No.10-3039 and its counterpart U.S. patent application Ser. No. 873,606 (Application Date: Jun. 12, 1997) also use a reflecting-refracting type of optical system incorporating a concave mirror, etc., but without a beam splitter, and can also be employed with this invention. The disclosures in the abovementioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be released mechanically to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

This invention is not limited to use for the chamber assembly that isolates the wafer stage assembly from the atmospheric condition as described in the embodiments. Instead, this invention can also be used to isolate the reticle (mask) stage assembly 76 from the atmospheric condition. Similarly, this invention can be used to isolate the projection lens assembly 78.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and purity are controlled.

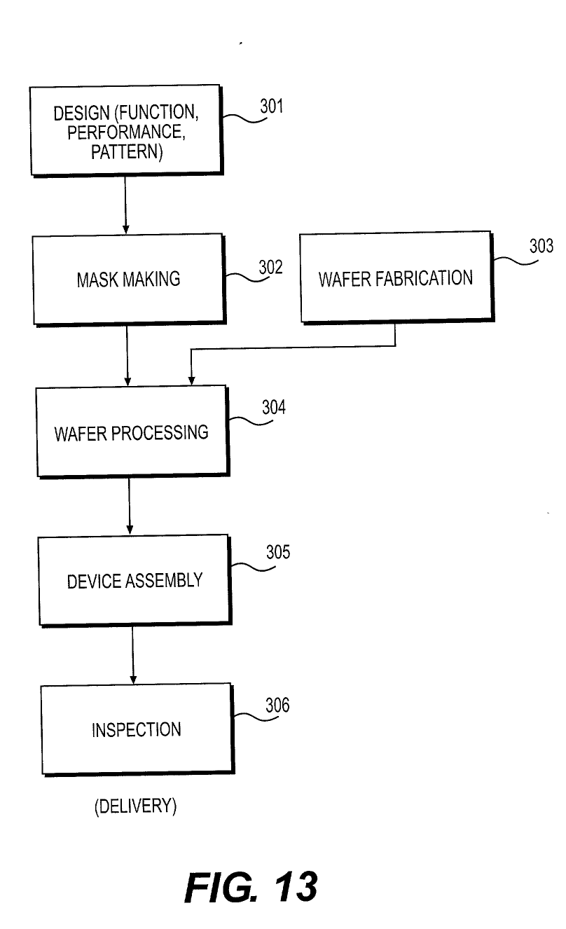

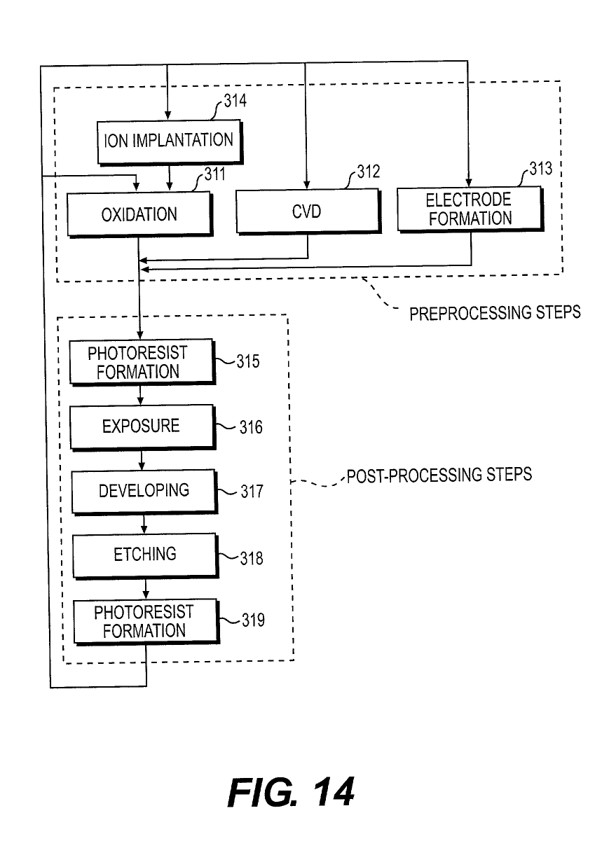

Further, semiconductor devices can be fabricated using the above described systems, by the process shown generally in FIG. 13. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 305 the semiconductor device is assembled (including the dicing process, bonding process and packaging process), then finally the device is inspected in step 306.

FIG. 14 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted In the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed.

Multiple circuit patterns are formed by repetition of these preprocessing and post-processing steps.

It will be apparent to those skilled in the art that various modifications and variations can be made in the wafer stage chamber assembly, the components thereof, and the methods described, the material chosen for the present invention, and in construction of the wafer stage chamber assembly, the photolithography systems as well as other aspects of the invention without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalent.

We claim:

1. A base assembly for a stage chamber assembly of a stage device, the stage device being used in an exposure apparatus, the base assembly comprising:
a base frame to support the stage device, the base frame having a front section and a rear section; and
a plurality of support members to kinematically support the stage chamber assembly, the plurality of support members removably attaching the base frame to a frame of the exposure apparatus.

2. The base assembly of claim 1, further comprising:
a stage base providing an air bearing support to the stage device.

3. The base assembly of claim 2, wherein the stage base is made of ceramic.

4. The base assembly of claim 2, wherein the stage base has a flat top surface.

5. The base assembly of claim 2, wherein an underside of the stage base comprises a first strengthening rib structure.

6. The base assembly of claim 5, wherein the first strengthening rib structure has a multi-radial configuration, each radial configuration centering on a pivotal support point for the stage device.

7. The base assembly of claim 6, wherein the base frame comprises a plurality of attachment ports to kinematically support the stage base, each attachment port being positioned corresponding to the pivotal support point.

8. The base assembly of claim 1, wherein an underside of the base frame comprises a second strengthening rib structure.

9. The base assembly of claim 8, wherein the second strengthening rib structure comprises a plurality of rib segments connecting the pivotal support points.

10. The base assembly of claim 1, wherein the base frame comprises a plurality of support mounting surfaces to engage with a corresponding plurality of mounting surfaces of the plurality of support members.

11. The base assembly of claim 1, wherein the base frame tapers toward corners of the rear section of the base frame.

12. The base assembly of claim 2, further comprising:
at least one reaction frame base positioned adjacent the stage base, each of the at least one reaction frame base to support at least one of a reaction frame and a mover assembly.

13. The base assembly of claim 12, wherein the at least one reaction frame base is made of ceramic.

14. The base assembly of claim 12, wherein the at least one reaction frame base has a flat top surface.

15. The base assembly of claim 12, further comprising:
an accessory channel positioned adjacent the at least one reaction frame base.

16. The base assembly of claim 12, further comprising:
an accessory channel positioned between the stage base and one of the at least one reaction frame base.

17. The base assembly of claim 16, wherein the accessory channel is a cut-out portion of at least one of the stage base and the base frame.

18. The base assembly of claim 1, wherein the plurality of support members comprise:
at least one front support member removably attached to the front section of the base frame; and
at least one rear support member removably attached to the rear section of the base frame.

19. The base assembly of claim 18, wherein the plurality of support members comprises:
at least one support strut removably attaching the plurality of support members to the base frame.

20. The base assembly of claim 1, further comprising:
a bottom plate positioned at an underside of the base frame to add stiffness of the base frame.

21. The base assembly of claim 20, wherein the bottom plate is removably fastened to the base frame.

22. The base assembly of claim 21, wherein the bottom plate is an integral part of the base frame.

23. The base assembly of claim 20, further comprising:
at least one damping element positioned between the base frame and the bottom plate.

24. The base assembly of claim 1, further comprising:
a wedge jack to provide a locking engagement between one of the plurality of the support members and the base frame, the wedge jack including a driving wedge and at least one wedge portion.

25. The base assembly of claim 24, wherein the driving wedge has a threaded opening to receive a threaded key.

26. The base assembly of claim 24, wherein the base frame has a wedge opening having a corresponding configuration to the wedge jack at a position of the locking engagement.

27. The base assembly of claim 1, further comprising:
a shear panel attached to the front section of the base frame, the shear panel having sufficient stiffness to prevent the base frame from vibrating.

28. The base assembly of claim 27, wherein the shear panel is attached to at least one of the plurality of support members.

29. The base assembly of claim 27, wherein the shear panel comprises:
at least one loader port to load and unload the semiconductor substrates through the shear panel into the stage chamber assembly.

30. The base assembly of claim 27, wherein the shear panel further comprises:
at least one climate access port to control air condition within the stage chamber assembly.

31. A projection lens assembly comprising the base assembly of claim 1.

32. An object on which an image has been formed by the projection lens assembly of claim 31.

33. A lithography system comprising the base assembly of claim 1.

34. A device manufactured with the lithography system of claim 33.

35. A base assembly for a stage device, the stage device having at least one mover assembly, the base assembly comprising:
a stage base to support the stage device; and
at least one mover base to support the at least one mover assembly, the at least one mover base being positioned sandwiching the stage base.

36. The base assembly of claim 35, wherein the stage base is made of ceramic.

37. The base assembly of claim 35, wherein the stage base has a top flat surface.

38. The base assembly of claim 35, wherein the at least one mover base is made of ceramic.

39. The base assembly of claim 38, wherein the at least one mover base has a top flat surface.

40. The base assembly of claim 35, wherein the at least one mover base comprises a pair of mover bases, each mover base being fastened to one of a pair of parallel edges of the stage base.

41. The base assembly of claim 35, further comprising:
a pair of base supports to support the stage base and the at least one reaction frame base, the pair of base supports being fastened to and positioned parallel to a second pair of parallel edges of the stage base.

42. The base assembly of claim 41, further comprising:
an accessory channel provided adjacent at least one of the stage base, the at least one reaction frame base, and the pair of base supports.

43. The base assembly of claim 35, further comprising:
a base frame to kinematically support at least one of the stage base and the pair of base supports.

44. The base assembly of claim 43, further comprising:
a plurality of support members for attaching the base frame to a frame.

45. A projection lens assembly comprising the base assembly of claim 35.

46. An object on which an image has been formed by the projection lens assembly of claim 45.

47. A lithography system comprising the base assembly of claim 35.

48. A device manufactured with the lithography system of claim 47.

49. A stage device for use in an exposure apparatus to manufacture semiconductor substrates, comprising:
a stage base to support the stage device, an underside of the stage base having a strengthening rib structure wherein the strengthening rib structure has a multi-radial configuration, each radial configuration centering on a pivotal support point for the stage device.

50. The stage device of claim 49, wherein the stage base is made of ceramic.

51. The stage device of claim 49, wherein the stage base has a top flat surface.

52. A projection lens assembly comprising the stage device of claim 49.

53. An object on which an image has been formed by the projection lens assembly of claim 52.

54. A lithography system comprising the stage device of claim 49.

55. A device manufactured with the lithography system of claim 54.
